(19) United States
(12) Patent Application Publication
(10) Pub. No.: US 2024/0096361 A1
(43) Pub. Date: Mar. 21, 2024

(54) MAGNETIC DISK DEVICE

(71) Applicants: Kabushiki Kaisha Toshiba, Tokyo (JP); Toshiba Electronic Devices & Storage Corporation, Tokyo (JP)

(72) Inventor: Yuugo TANNO, Kawasaki Kanagawa (JP)

(21) Appl. No.: 18/119,515

(22) Filed: Mar. 9, 2023

(30) Foreign Application Priority Data
Sep. 21, 2022 (JP) 2022-150061

(51) Int. Cl. G11B 5/60; G11B 27/36

(52) U.S. Cl. CPC G11B 5/607; G11B 27/36

(57) ABSTRACT

According to one embodiment, a magnetic disk device includes a magnetic disk, a magnetic head including a write head, a read head, a heater which adjusts a flying height of the read head and a detection portion which detects a flying height of the read head, and a controller which controls a power value supplied to the heater in accordance with the flying height, and, when a read error occurs, detects, with the detection portion, the flying height of the read head in an error occurrence region, determines an assist amount to bring the flying height in the error occurrence region to a pre-set reference flying height, and executes re-try read of the error occurrence region while inputting a power value corresponding to the assist amount to the heater.

### CROSS-REFERENCE TO RELATED APPLICATIONS

This application is based upon and claims the benefit of priority from Japanese Patent Application No. 2022-150061, filed Sep. 21, 2022, the entire contents of which are incorporated herein by reference.

### FIELD

Embodiments described herein relate generally to a magnetic disk device.

### BACKGROUND

Magnetic disk devices, which are hard disk devices, have a magnetic disk as a magnetic medium and a magnetic head which writes and reads data with respect to the magnetic disk. The magnetic head includes a heater. The amount of protrusion of the magnetic head varies according to the power value supplied to the heater. The magnetic disk devices are subjected to adjust the function of dynamic flying height (DFH) in advance in the test procedure so as to make the flying height between the magnetic disk and the magnetic head appropriate.

The adjustment of the DFH function is, for example, the setting of the flying height. The setting of the flying height is carried out by, first, specifying the power value supplied to the heater when the magnetic disk and the magnetic head are brought into contact with each other, and then decreasing the power value until a desired flying height is achieved. In an actual magnetic disk, physical distortion exists, and therefore the above-described setting is carried out with reference to the set position closest to the magnetic head within one rotation cycle of the magnetic disk. With this configuration, there are positions on the magnetic disk, which are further away from the magnetic head than the set position, and read errors may occur at positions other than the set position.

### BRIEF DESCRIPTION OF THE DRAWINGS

FIG. 1 is a block diagram showing a configuration of a magnetic disk device according to an embodiment.

FIG. 2 is a perspective view showing magnetic heads and magnetic disks of the magnetic disk device in the embodiment.

FIG. 3 is an enlarged cross-sectional view of a magnetic head and a magnetic disk of the magnetic disk device in the embodiment.

FIG. 4 is a graph illustrating a relationship between HDIs value and DFH value.

FIG. 5 is a graph illustrating a change in HDIs value when a magnetic disk is rotated once.

FIG. 6 is a flowchart showing a procedure of read process of the magnetic disk device in the embodiment.

### DETAILED DESCRIPTION

Embodiments will be described hereinafter with reference to the accompanying drawings.

In general, according to one embodiment, a magnetic disk device comprises a magnetic disk, a magnetic head including a write head which writes data to the magnetic disk, a read head which reads data from the magnetic disk, a heater which adjusts a flying height of the read head and a detection portion which detects a flying height of the read head, and a controller which controls a power value supplied to the heater in accordance with the flying height, and, when a read error occurs, detects, with the detection portion, the flying height of the read head in an error occurrence region in the magnetic disk, determines an assist amount to bring the flying height in the error occurrence region to a pre-set reference flying height, and executes re-try read of the error occurrence region while inputting a power value corresponding to the assist amount to the heater.

A magnetic disk device according to an embodiment will be described below with reference to the drawings.

Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

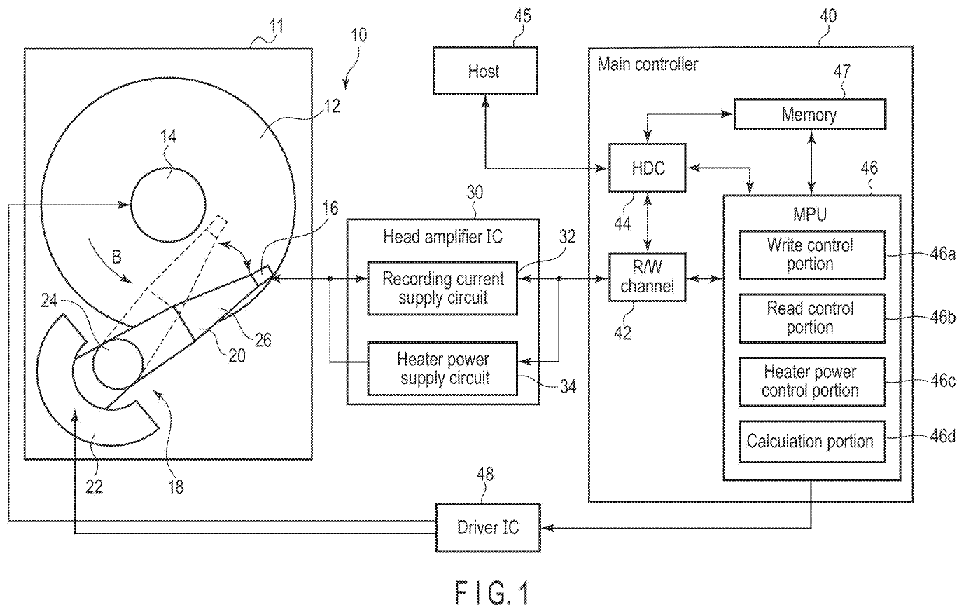

FIG. 1 is a block diagram showing a configuration of a magnetic disk device 10 according to an embodiment.

As shown in FIG. 1, the magnetic disk device 10 comprises a rectangular housing 11, a magnetic disk 12 disposed as a recording medium in the housing 11, a spindle motor 14 which supports and rotates the magnetic disk 12, and a plurality of magnetic heads 16 which write (record) and read (reproduce) data with respect to the magnetic disk 12.

The magnetic disk device 10 includes a head actuator 18 which moves and positions a respective magnetic head 16 on an arbitrary track on the magnetic disk 12. The head actuator 18 includes a carriage assembly 20 which movably supports the magnetic head 16 and a voice coil motor (VCM) 22 which pivots the carriage assembly 20.

The carriage assembly 20 includes a bearing portion 24 rotatably supported by the housing 11 and a plurality of suspensions 26 extending from the bearing portion 24. The magnetic head 16 is supported at a distal end of each suspension 26.

The magnetic disk device 10 comprises a head amplifier IC (preamplifier) 30 which drives the magnetic heads 16, a main controller 40 and a driver IC 48. The head amplifier IC 30 is electrically connected to the magnetic heads 16. The head amplifier IC 30 comprises a recording current supply circuit 32 which supplies recording current to the recording coil of each of the magnetic heads 16, a heater power supply circuit 34 which supplies power to a heater H, which will be described later, and an amplifier, not shown, which amplifies a signal read by a magnetic head.

The main controller 40 and the driver IC 48 are configured, for example, on a control circuit board, not shown, provided on a rear surface side of the housing 11. The main controller 40 comprises an R/W channel 42, a hard disk controller (HDC) 44, a microprocessor (MPU) 46, a memory 47 and the like. The main controller 40 is electrically connected to the VCM 22 and the spindle motor 14 via a driver IC 48. The HDC 44 can be connected to a host computer (host) 45.

The R/W channel 42 is a signal processing circuit for read/write data. The HDC 44 controls data transfer between the host 45 and the R/W channel 42 in response to the instruction from the MPU 46. The HDC 44 is electrically connected to, for example, the R/W channel 42, the MPU 46, the memory 47 and the like. The memory 47 includes a volatile memory and a nonvolatile memory. For example, the memory 47 includes a buffer memory formed using a DRAM, and a flash memory. The memory 47 stores programs and parameters necessary for processing by the MPU 46.

The MPU 46 is a main control portion of the magnetic disk devise 10 and executes servo control necessary for controlling read/write operations and positioning of the magnetic head 16. The MPU 46 includes a write control portion 46a which controls write processing, a read control portion 46b which controls read processing, a heater power control portion 46c which controls the power value supplied to the heater H, which will be described later, a calculation portion 46d which calculates the power supplied to the heater based on the flying height detected by the detection portion 74, which will be described later, and the sensitivity of the detection portion 74 stored in the memory 47 in advance, and the like.

The write control portion 46a controls the data write processing in accordance with commands from the host 45 and the like. More specifically, the write control portion 46a controls the VCM 22 via the driver IC 48 to position the magnetic head 16 at a predetermined position on the magnetic disk 12 and write data.

The read control portion 46b controls the data read processing according to commands from the host 45 and the like. More specifically, the read control portion 46b controls the VCM 22 via the driver IC 48 to position the magnetic head 16 at a predetermined position on the magnetic disk 12 and read data.

When a read error occurs, the calculation portion 46d calculates the assist amount, which will be described later, and calculates out the power value (the power value supplied to the heater H) according to the assist amount.

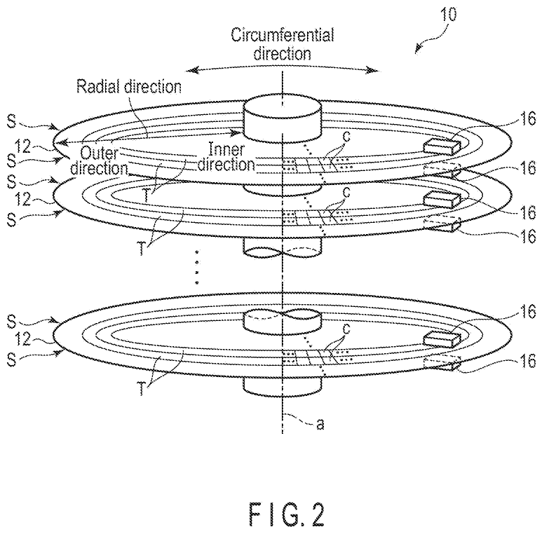

FIG. 2 is a perspective view showing the magnetic heads 16 and the magnetic disks 12 of the magnetic disk device 10 of the embodiment. As shown in FIG. 2, the magnetic disk device 10 includes a plurality of magnetic heads 16 and a plurality of magnetic disks 12. The magnetic heads 16 and the magnetic disks 12 are arranged side by side along a rotation axis a.

Each of the magnetic disks 12 comprises a pair of recording surfaces S and includes a plurality of tracks T along a circumferential direction and a plurality of sectors C constituted by dividing the tracks T along the circumferential direction. The tracks T are arranged and located along a radial direction. The sectors C are storage areas to which data are written and to which logical block addresses (LBAs) are assigned.

Each of the magnetic heads 16 opposes one recording surface S. The main controller 40 can control each of the magnetic heads 16 individually. For example, the main controller 40 can control the heater power supply circuit 34 by the heater power control portion 46c to individually adjust the power value supplied to each of the magnetic heads 16.

Note that the magnetic disk apparatus 10 is not limited to a configuration with a plurality of magnetic heads 16 and a plurality of magnetic disks 12, but may be of a configuration with, for example, a single magnetic head 16 and a single magnetic disk 12.

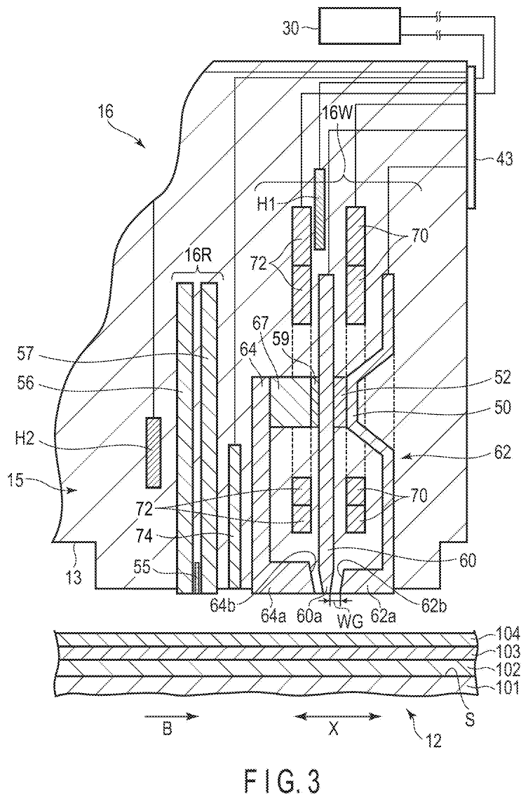

FIG. 3 is an enlarged cross-sectional view of a magnetic head 16 and a magnetic disk 12 of the magnetic disk device 10 according to the embodiment. As shown in FIG. 3, the magnetic head 16 includes a write head 16W and a read head 16R formed by a thin-film process on an end portion of the slider 15, and is formed as a separated type head. The slider 15 includes an air bearing surface (ABS: head surface) 13, which is a surface opposing the recording surface S of the magnetic disk 12 to fly from the recording surface S of the magnetic disk 12. The write head 16W writes data on the magnetic disk 12. The read head 16R reads out data recorded on the magnetic disk 12.

The magnetic disk 12 is configured as a perpendicular magnetic recording medium. The magnetic disk 12 is formed into a discoidal shape of, for example, 96 mm (about 3.5 inches) in diameter, and includes a substrate 101 made of a non-magnetic material. On each of the surfaces (recording surfaces S) of the substrate 101, a soft magnetic layer 102 made of a material exhibiting soft magnetic properties as an underlying layer, and a perpendicular magnetic recording layer 103 having magnetic anisotropy in a direction perpendicular to the surface of the magnetic disk 12 and a protective film 104 are stacked as upper layers in order. The magnetic disks 12 are coaxially engaged with each other on the hub of the spindle motor 14. The magnetic disks 12 are rotated by the spindle motor 14 in a direction indicated by arrow B at a predetermined speed (see FIG. 1).

The read head 16R includes a magnetoresistive effect element 55, a first magnetic shield film 56 and a second magnetic shielding film 57 arranged to sandwich the magnetoresistive effect element 55 along a longitudinal direction X of a recording track formed on the perpendicular magnetic recording layer 103. The magnetoresistive element 55 and each of the magnetic shield films 56 and 57 extend approximately perpendicular to the ABS 13. Lower end portions (distal end portions) of the magnetoresistive effect element 55 and each of the magnetic shield films 56 and 57 protrude slightly from the ABS 13.

The write head 16W includes a main magnetic pole 60, a return magnetic pole 62, a non-conductor 52, a leading magnetic pole 64, a second connection portion 67, a first recording coil 70, and a second recording coil 72. The main magnetic pole 60, the return magnetic pole 62 and the leading magnetic pole 64 are formed of a highly magnetic permeable material. The main magnetic pole 60 and the return magnetic pole 62 constitute a first magnetic core which forms a magnetic path, and the main magnetic pole 60 and the leading magnetic pole 64 constitute a second magnetic core which forms a magnetic path.

The main magnetic pole 60 extends approximately perpendicular to the ABS 13. A distal end portion 60a of the main magnetic pole 60, located on an ABS 13 side is tapered down toward the ABS 13 to form a columnar shape which is narrower in width than the other parts. The distal end portion 60a of the main magnetic pole 60 protrudes slightly from the ABS 13 of the slider 15.

The return magnetic pole 62 is provided to efficiently close the magnetic path via the soft magnetic layer 102 of the magnetic disk 12 directly underneath the main magnetic pole 60. The return magnetic pole 62 is formed into an approximately L-shape, and a distal end portion 62a thereof is formed into a slender rectangular shape. The distal end portion 62a of the return magnetic pole 62 protrudes slightly from the ABS 13 of the slider 15. The distal end portion 62a includes a magnetic pole end surface 62b opposing the distal end portion 60a of the main magnetic pole 60 with a write gap WG therebetween. The magnetic pole end surface 62b extends perpendicular or slightly inclined to the ABS 13.

The return magnetic pole 62 includes a first connection portion 50 connected to the main magnetic pole 60. The first connection portion 50 is magnetically connected to an upper part of the main magnetic pole 60, that is, a part of the main magnetic pole 60, which is away from the ABS 13, via the non-conductor 52. The first recording coil 70 is wound around the first connection portion 50, for example, in the first magnetic core. When writing signals to the magnetic disk 12, a write current is allowed to flow to the first recording coil 70, and thus the first recording coil 70 excites the main magnetic pole 60 and causes a magnetic flux to flow to the main magnetic pole 60.

The leading magnetic pole 64 is provided on a leading side of main magnetic pole 60 so as to oppose the main magnetic pole 60. The leading magnetic pole 64 is formed in an approximately L-shape, and the distal end portion 64a on the ABS 13 side is formed into a slender rectangular shape. The distal end portion 64a protrudes slightly from the ABS 13 of the slider 15. The distal end portion 64a includes a magnetic pole end surface 64b opposing the distal end portion 60a of the main magnetic pole 60 with a gap therebetween.

Further, the leading magnetic pole 64 includes a second connection portion 67 joined to the main magnetic pole 60 at a position away from the ABS 13. The second connection portion 67 is formed, for example, of a soft magnetic material and is magnetically connected to an upper part of the main magnetic pole 60, that is, the part of the main magnetic pole 60, which is away from the ABS 13, via a non-conductor 59. Thus, the second connection portion 67 forms a magnetic circuit together with the main magnetic pole 60 and the leading magnetic pole 64. The second recording coil 72 is wound, for example, around the second connection portion 67 so as to apply a magnetic field to the magnetic circuit.

Further, the magnetic head 16 includes a heater H and a detection portion 74. For example, the heater H comprises a first heater H1 which heats the area around the write head 16W and a second heater H2 which heats the area around the read head 16R. The first heater H1 and the second heater H2 are each connected to the head amplifier IC 30 via wiring and connection terminals 43. A desired power value is supplied to each of the first heater H1 and the second heater H2 from the heater power supply circuit 34 of the head amplifier IC 30. The first heater H1 adjusts the flying height of the write head 16W by heating the area around the write head 16W, and the second heater H2 adjusts the flying height of the read head 16R by heating the area around the read head 16R. The structure of the heater H is not limited to that constituted by two heaters, the first heater H1 and the second heater H2, but may, for example, be of a structure of single heater which heats the read head 16R. Hereinafter, the “power value supplied to the heater H” is referred to as the “DFH value” as well.

The detection portion 74 is provided in the vicinity of the heater H and is located, for example, between the first heater H1 and the second heater H2. The detection portion 74 detects the flying height of the read head 16R. For example, the detection portion 74 detects the distance from the recording surface S of the magnetic disk 12 to the ABS 13 of the magnetic head 16. The detection portion 74 may as well be capable of detecting the flying height of the write head 16W. The term “flying height” used here may as well be the distance from the magnetic disk 12 to the magnetic head 16.

The detection portion 74 is, for example, a head disk interface (HDI) sensor which detects the flying height based on change in electrical resistance value, which is caused by change in temperature. The HDI sensor is, for example, a resistance element.

The principle of the HDI sensor will now be explained. To the HDI sensor, a constant current is applied from a power supply source (not shown). When power is applied to the heater H (for example, the first heater H1 or the second heater H2), the magnetic head 16 (for example, the write head 16W or the read head 16R) is heated so as to protrude toward the magnetic disk 12. In this manner, the HDI sensor as well is heated, thus raising the electrical resistance of the HDI sensor. As a result, the output value output from the HDI sensor increased. In other words, as the flying height decreases, the output value of the HDI sensor increases. In other words, the output value output of the HDI sensor is inversely proportional to the flying height of the magnetic head 16.

Hereinafter, the “value of output from the HDI sensor” may as well be referred to as the “HDIs value”. For example, the HDIs value is the value of an output from the HDI sensor, which corresponds to the flying height of the read head 16R.

Note that the detection portion 74 is not limited to an HDI sensor, but may as well be, for example, a sensor which detects the flying height from the electrostatic capacitance between the recording surface S of the magnetic disk 12 and the ABS 13 of the magnetic head 16. An example of the case where the detection portion 74 is an HDI sensor will now be described.

Here, the adjustment of a dynamic flying height (DFH) function, which is carried out in the test process in advance, will be explained. The DFH function is a function that enables control of the flying height by using the heater H mounted on the magnetic head 16. The adjustment of the DFH function includes, for example, the setting of the flying height.

The setting of the flying height is carried out by, first, specify a DFH value at the time when the magnetic disk 12 and magnetic head 16 come into contact with each other, and then reducing the DFH value until the flying height of magnetic head 16 reaches the predetermined desired flying height. Here, the magnetic disk 12 includes physical distortion, and therefore the setting of the flying height is carried out with reference to a first position (setting position) P1 on the magnetic disk 12, which is closest in distance to the magnetic head 16. More specifically, the DFH value at which the magnetic head 16 is brought into contact with the first position P1 is specified, and the DFH value is reduced until the flying height of the magnetic head 16 from the first position P1 becomes the predetermined desired flying height.

The flying height is set as described above, and as a result, the flying height of the read head 16R with respect to a position other than the first position P1 on the magnetic disk 12 is larger than the pre-set flying height. Therefore, read errors may occur at positions other than the first position P1.

When a read error occurs, the magnetic disk device 10 of this embodiment detects the flying height in an error occurrence region with the detection portion 74, and determines the assist amount to make the flying height in the error occurrence region to the pre-set flying height. Then, while inputting the power value corresponding to the assist amount to the heater H (the second heater H2), the error occurrence region is retry-read. Note here that, the term “retry-read” means reading data again. Hereinafter, the “flying height detected at the setting position P1” is referred to as the “reference flying height”. Further, the “DFH value pre-set at the setting position P1” may as well be referred to as the “reference power value”.

Moreover, in this embodiment, the sensitivity α of the detection section 74 is specified in the testing process.

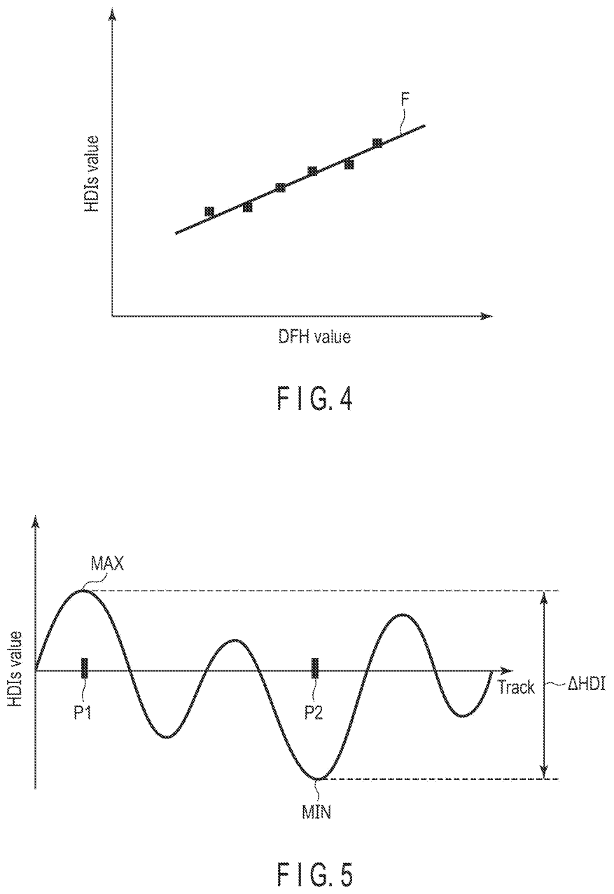

FIG. 4 is a graph showing the relationship between the HDIs value and the DFH value. The HDIs value set out in FIG. 4 is the average of HDIs values for one rotation cycle along a track T. The HDIs value in FIG. 4 is not limited to the average value, but may as well be, for example, the value at the first position P1.

As shown in FIG. 4, as the DFH value is increased, the HDIs value also increases. Further, the DFH value and the HDIs value have a substantially linear relationship.

Here, when HDIs values are obtained while varying the DFH value and the obtained HDIs is subjected to the first-order approximation, the following relation formula F can be obtained. Note that y represents the HDIs value, and a represents the sensitivity (HDIs sensitivity).

y=αx+β (Relation formula F)

The sensitivity α is the sensitivity of the detection section 74 to changes in DFH values and corresponds to the slope of the graph. The sensitivity α is stored in the memory 47 in advance.

FIG. 5 is a graph showing the change in HDIs value when the magnetic disk 12 is rotated by one cycle. As shown in FIG. 5, the HDIs value changes according to the distortion of the magnetic disk 12.

The position where the HDIs value becomes the maximum value MAX of the HDIs values in one rotation cycle is the position closest to the magnetic head 16 and corresponds to the setting position P1 at the time when the flying height is set. Further, the maximum value MAX corresponds to the reference flying height. The second position P2, where the HDIs value becomes the minimum value MIN of the HDIs values in one rotation cycle, is the position farthest from the magnetic head 16.

An example of calculation of the assist amount will now be explained.

When a read error occurs, the calculation portion 46d calculates the difference between the HDIs value in the error occurrence region and the HDIs value at the setting position P1. For example, when the error occurrence region is the second position P2, the difference (ΔHDI) between the HDIs value at the second position P2 and the HDIs value at the setting position P1 is calculated. Note here that the HDIs value at the second position P2 corresponds to the flying height in the error occurrence region, and the HDIs value at the setting position P1 corresponds to the reference flying height.

The calculation portion 46d determines the assist amount according to the above-described difference and the sensitivity α obtained in advance in the testing process. For example, when the error occurrence region is the second position, the assist amount is determined according to the difference (ΔHDI) and sensitivity α. The assist amount is the value obtained by dividing the difference by the sensitivity α, and when the second position P2 is the error occurrence region, it can be expressed by the following formula. Note that ΔHDI represents the difference and α represents the sensitivity.

Assist amount=ΔHDI/α

The power value corresponding to the assist amount is, for example, the power value obtained by adding the assist amount to the reference power value.

Next, the procedure of read process will be described.

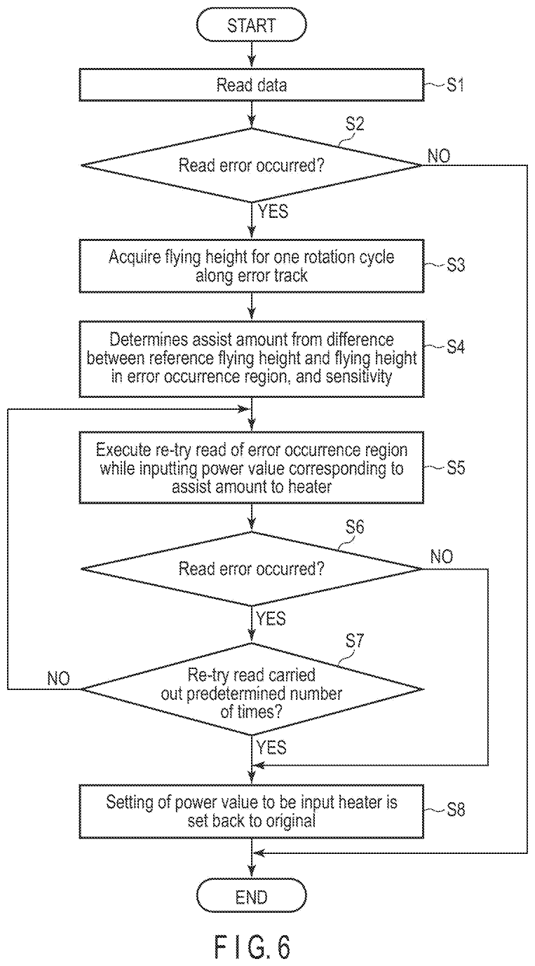

FIG. 6 is a flowchart showing the procedure of read process of the magnetic disk device 10 in the above-described embodiment. As shown in FIG. 6, when the read process starts, first, the main controller 40 reads data (S1). Then, the main controller 40 determines whether or not a read error has occurred (S2). If no read error has occurred, the read process is finished.

If a read error has occurred (S2), the main controller 40, by means of the detection portion 74, acquires the flying height for one rotation cycle along the track (error track) where the read error has occurred (S3). Next, the main controller 40 determines the assist amount according to the difference between the pre-set reference flying height and the flying height in the error occurrence region, and the sensitivity stored in the memory 47 in advance (S4).

Subsequently, the main controller 40 executes a re-try read of the error occurrence region (S5) while inputting the power value corresponding to the assist amount obtained in Step S4 to the heater H, and determines whether or not the read error still occurs (S6). If no read error is occurring, the setting of the power value to be input to heater H is set back to the original power value irrespective of the assist amount (S8), and the read process is finished.

If the read error is still occurring (S6), the main controller 40 determines whether or not the re-try read has been carried out a predetermined number of times (S7). If the re-try read has not been carried out the predetermined number of times, Steps S5 and S6 are repeated. When the re-try read has been carried out the predetermined number of times, Step S8 is executed and the read process is finished.

Note that the “flying height” in Step S3 can as well be rephrased as the “output value corresponding to the flying height”, the “reference flying height” in Step S4 as the “output value corresponding to the flying height at the setting position P1” and the “flying height in the error occurrence region” in Step S4 as the “output value corresponding to the flying height in the error occurrence region”. For example, when the detection portion 74 is an HDI sensor, the above-described output value is the HDIs value.

Note that the predetermined number of times in step S6 is an arbitrary number of times set in the test process, which is, for example, 80 times. Further, the re-try read in step S5 may be carried out under different conditions. For example, when moving the read head 16R to a target sector, it may be moved to a slightly shifted (offset) position. Further, after the re-try read is carried out multiple times, the parameters may be recursively used and the re-try read may be carried out. When proceeding to Step S8 after the re-try read has carried out a predetermined number of times in step S7, such an event that data could not be read and also the address of the error occurrence region and the like, may be stored in the memory 47.

According to the magnetic disk device 10 configured as described above, when a read error occurs, the main controller 40 acquires the flying height in the error occurrence region, and determines the assist amount to bring the flying height in the error occurrence region to the pre-set reference flying height. Further, while inputting the power value corresponding to the assist amount to the heater H, it executes the re-try read of the error occurrence region.

In this manner, it possible to carry out the read at the optimum flying height even at positions other than the set position P1, thereby improving the accuracy of the read process and obtaining a highly reliable magnetic disk device 10.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a magnetic disk;
a magnetic head including a write head which writes data to the magnetic disk, a read head which reads data from the magnetic disk, a heater which adjusts a flying height of the read head and a detection portion which detects a flying height of the read head; and
a controller which controls a power value supplied to the heater in accordance with the flying height, and, when a read error occurs, detects, with the detection portion, the flying height of the read head in an error occurrence region in the magnetic disk, determines an assist amount to bring the flying height in the error occurrence region to a pre-set reference flying height, and executes re-try read of the error occurrence region while inputting a power value corresponding to the assist amount to the heater.

2. The magnetic disk device of claim 1, wherein
the controller, when a read error occurs,
acquires the flying height for one rotation cycle along a track on which the read error occurred,
determines the assist amount according to a difference between the reference flying height and the flying height in the error occurrence region, and
executes a re-try read of the error occurrence region while inputting to the heater a power value obtained by adding a power value corresponding to the assist amount to a pre-set reference power value.

3. The magnetic disk device of claim 2, wherein
the reference flying height is a maximum flying height in flying heights obtained in one rotation cycle, and
the flying height in the error occurrence region is a minimum flying height of the flying heights obtained in one rotation cycle.

4. The magnetic disk device of claim 2, wherein
the controller
comprises a memory which stores a sensitivity of the detection portion with respect to change in the power value supplied to the heater, and
determines the assist amount according to the difference and the sensitivity.

5. The magnetic disk device of claim 1, wherein
the detection portion is an HDI sensor which measures the flying height based on a change in electrical resistance value caused by change in temperature.
